(19) United States
(12) Patent Application Publication
(10) Pub. No.: US 2006/0153170 A1
(43) Pub. Date: Jul. 13, 2006

(54) LAN-based small office/home telephone network utilizing intelligent terminals

(76) Inventor: Amitabha Gupta, Bethlehem, PA (US)

Correspondence Address: Wendy W. Koba, Esq., PO Box 556, Springtown, PA, 18081, US

(21) Appl. No.: 11/302,926

(22) Filed: Dec. 14, 2005

Related U.S. Application Data
(60) Provisional application No. 60/636,084, filed on Dec. 14, 2004.

(51) Int. Cl. H04L 12/66

(52) U.S. Cl. 370/352

(57) ABSTRACT

A LAN-based communication arrangement particularly well-suited for small office/home office arrangements includes a plurality of “intelligent terminals” that each include a CPU that stores information regarding the IP address of each terminal on the LAN, as well as POTS line(s) associated with that location. The terminals are able to communicate with each other over the LAN, as well as communicate with others via the POTS connections. PBX-like functions such as conference, hold, transfer, etc. are possible by virtue of maintaining status and identity information for each terminal within the CPU's of the terminals.

### CROSS-REFERENCE TO RELATED APPLICATION

The application claims the benefit of U.S. Provisional Application No. 60/636,084, filed Dec. 14, 2004.

### TECHNICAL FIELD

The present invention is directed to an improved telecommunications network suitable for small office/home applications and, more particularly, to the utilization of “intelligent terminals” as the telephone appliances, the terminals functioning to network themselves and provide capabilities such as conferencing, intercom, transfer, hold, etc., without the need for a PBX or any type of centralized controller.

### BACKGROUND OF THE INVENTION

The home telecommunications network, or any other small, non-professionally run network, presents special problems. First, the network desired by the user may require infrastructure that the user may not want, or may not be able to install without professional help. Currently, the already-existing infrastructure of telephone lines or electrical wiring may be used as part of the transmission media for the network. Alternatively, a wireless transmission system may also be used as a transmission medium. These transmission media cannot currently be combined in a single network. Current art provides connectivity between an outside wide area network (WAN) and a single home local area network (LAN) on a phone line, an electrical wiring arrangement, or through wireless media. The problem is that a seamless network from anywhere in the home is not always possible. For example, there is not always a phone jack in every room, or an electrical wire may not provide a reliable connection between certain places in the home. Consequently, the reach of the home LAN is limited to the reach of the particular physical medium used. It is desirable to increase the home network access by combining multiple transmission media in a single network.

The second difficulty associated with home networks is the need for the home network to be easily operated and maintained by a user who is not a computer professional. The home network needs to be as simple as possible. It is desirable to have a network that requires a minimum of manipulation on the part of the user in order to set up, operate and maintain the network.

One prior art attempt to address these problems is disclosed in U.S. Pat. No. 5,633,920 entitled “Smart Phone”, issued to D. Kikinis et al. on May 27, 1997, In the Kikinis et al. arrangement a “business telephone system” (such as used for a small office) includes a telephone that is configured into a “smart phone” that includes a serial link connection to a general computer. The smart phone includes additional connections to a PBX (if available) and other telephone extensions. Another arrangement, disclosed in U.S. Pat. No. 6,256,319, “‘Play and Plug’ Telephone System”, issued to J. H. Apgar et al. on Jul. 3, 2001, discloses a small business telephone system that utilizes a peer-to-peer protocol to provide communication within the business location. In one embodiment of the Apgar et al. arrangement, a key telephone system is employed, comprising a plurality of separate telephone sets. Each telephone set is coupled to at least one common communication channel, or telephone line and includes at least one tunable RF modem. Resources of the telephone system are allocated using the peer-to-peer protocol, and as each telephone set is newly added to the system, that set adaptively determines its own allocation of resources e.g., intercom numbers, etc. During operation, each telephone set requests the appropriate resources from its peers. However, Apgar et al. relies on the use of two separate communication channels: (1) a common “wireline” arrangement and (2) an RF communication line, as well as a central “box” or controller that provides the interface between the POTS lines and the telephone extensions and facilitates the allocation of RF channels, the assignment of extension numbers, etc. Additionally, such RF-based systems are limited in the number of telephones that can be handled (RF bandwidth limitations), and cannot easily provide the PBX-like features (e.g., hold, transfer, conference) enjoyed by most small system users.

Again, the provisioning of such a system would in most cases require an installer proficient in telecommunications applications. As such, the ability to modify the system as need be remains problematic.

### SUMMARY OF THE INVENTION

The needs remaining in the prior art are addressed by the present invention, which relates to an improved telecommunications network suitable for small office/home applications and, more particularly, to the utilization of “intelligent terminals” (in particular, digital devices) as the telephone appliances, the terminals functioning to network themselves and provide capabilities such as intercom between phones, conferencing (internal and/or external) and traditional POTS service.

In accordance with the present invention, a local area network (LAN) is configured within a given location (such as a small office or home telecommunications environment), where each intelligent terminal is formed to include hardware and software elements that allow the terminals to “find” and communicate with each other through the LAN. If two or more intelligent terminals are interconnected across the LAN without an external POTS capability, the terminals will function as an intercom system. If at least one intelligent terminal is also connected to a traditional POTS line, communication between an external telecommunications network and the local LAN will be supported for each terminal on the LAN. Each intelligent terminal also includes a pair of suitable computer connections, one for connecting the terminal to the LAN and another for allowing a personal computer to be directly coupled to the intelligent terminal. Unique IP addresses are used to define each “extension” terminal within the system.

In a preferred embodiment of the present invention, each intelligent terminal includes a “terminal table” defining the characteristics of that specific terminal (current status, IP address, etc.), as well as a “line table” identifying the associated POTS number, line IP address, UDP port and the like.

Other and further embodiments of the present invention will become apparent during the course of the following discussion and by reference to the accompanying drawings.

### BRIEF DESCRIPTION OF THE DRAWINGS

Referring now to the drawings, where like numerals represent like elements in several views:

FIG. 1 illustrates, in simplified form, an exemplary “intelligent terminal” communications network formed in accordance with the present invention;

FIG. 2 is a block diagram of various hardware components contained within an exemplary intelligent communication terminal of the present invention;

FIG. 3 illustrates an alternative network arrangement of intelligent terminal devices, with various ones of the terminals defined as “extensions” of other terminals, and local computers coupled to various other ones of the terminals;

FIG. 4 is a simplified block diagram of overall communication control process as implemented within each intelligent terminal; and

FIG. 5 is a diagram illustrating the interaction of the various components within the intelligent terminal.

### DETAILED DESCRIPTION

FIG. 1 illustrates an exemplary communication network of intelligent terminals, communicating via a local area network, as formed in accordance with the present invention. As shown, a backbone communication path 10 is disposed throughout a location in a manner that allows for the various intelligent communication terminals to be connected to backbone 10 and communicate with each other (as well as communicate externally through a traditional telephone network). A plurality of intelligent communication terminals 12-1 through 12-4 (which comprise digital communication devices) are illustrated in FIG. 1 as being connected to backbone communication path 10, where in each instance a first Ethernet port 14 is used to provide the communication between backbone 10 and terminal 12 (thus allowing each terminal to communicate with the other terminals on the LAN). A second Ethernet port 16 is associated with each intelligent terminal 12, and used as a communication port to a “local computer” that may be coupled to a specific intelligent terminal 12. In the particular embodiment illustrated in FIG. 1, intelligent terminal 12-1 is associated with a first local computer 18-1, where these two devices are coupled together through Ethernet port 16-1. Similarly, a second local computer 18-2 is coupled to intelligent terminal 12-4 through an Ethernet port 16-4 in terminal 12-4. It is to be understood that any suitable communication connection can be used, the Ethernet being just one example. Alternatively, it is possible (and quite likely) that a wireless connection may be used to provide communication between the terminal devices and the backbone, as well as between the terminals and their “local” computers. For example, wireless connections that embody the IEEE 802.11 wireless standard are commonplace and may be deployed in the arrangement of the present invention. Thus, while the remaining discussion will reference to “Ethernet connections” and “Ethernet ports”, this description is exemplary only and should not be considered to limit the scope of the present invention to that particular type of connection.

In accordance with the present invention, if two terminals are present on the LAN, with no interconnection to an external POTS line, the two terminals may communicate with each other in intercom fashion. Further, if at least one intelligent communication terminal 12 is coupled to a traditional telephone line (referred to as “plain old telephone service”, or POTS), this connection will provide telephony communication capabilities between the plurality of terminals 12 and the “outside world”. Thus, in accordance with the present invention, at least one intelligent communication terminal may also include a conventional telecommunications port, such as an RJ-11 connector. In the particular embodiment as shown in FIG. 1, intelligent communication terminals 12-2 and 12-4 are both illustrated as connected to a conventional telephone line, through POTS connectors 20-2 and 20-4, respectively.

In one embodiment, POTS line 22 may have a first telephone number and POTS line 24 may have a second telephone number. Alternatively, POTS lines 22 and 24 may simply define different locations within an establishment associated with the same incoming telephone line. In a residential environment, intelligent communication terminal 12-1 and associated computer 18-1 may be located in a “home office” room, where a LAN (RJ-45) connection is present (allowing connection to backbone 10), but a phone jack is not found. Intelligent communications terminal 12-4, alternatively, is located in a room with both an RJ-45 connection for backbone 10 and an RJ-11 connection for POTS line 24. Similarly, intelligent communication terminal 12-2 is located in proximity of both an RJ-11 connection (for POTS line 22) and a LAN connection to backbone 10. Remaining intelligent terminal 12-3, in this specific embodiment, is coupled only to backbone 10. It is an aspect of the present invention, however, that the “intelligence” built into each terminal 12 allows for an element such as terminal 12-3 to be afforded the same communication capabilities as its counterparts on the LAN. In contrast to conventional prior art small business phone systems, no other PBX or controlling apparatus is required in the implementation of the present invention. Simply having a plurality of such intelligent terminals is sufficient to provide these capabilities. For example, terminal 12-3 may take part in conversations with individuals on the other terminals (in an “intercom/conference” fashion), and may also be given access to one of the outside POTS lines. These various details of the present invention will be discussed in detail below in association with the remaining figures depicting the details of an exemplary intelligent communication terminal.

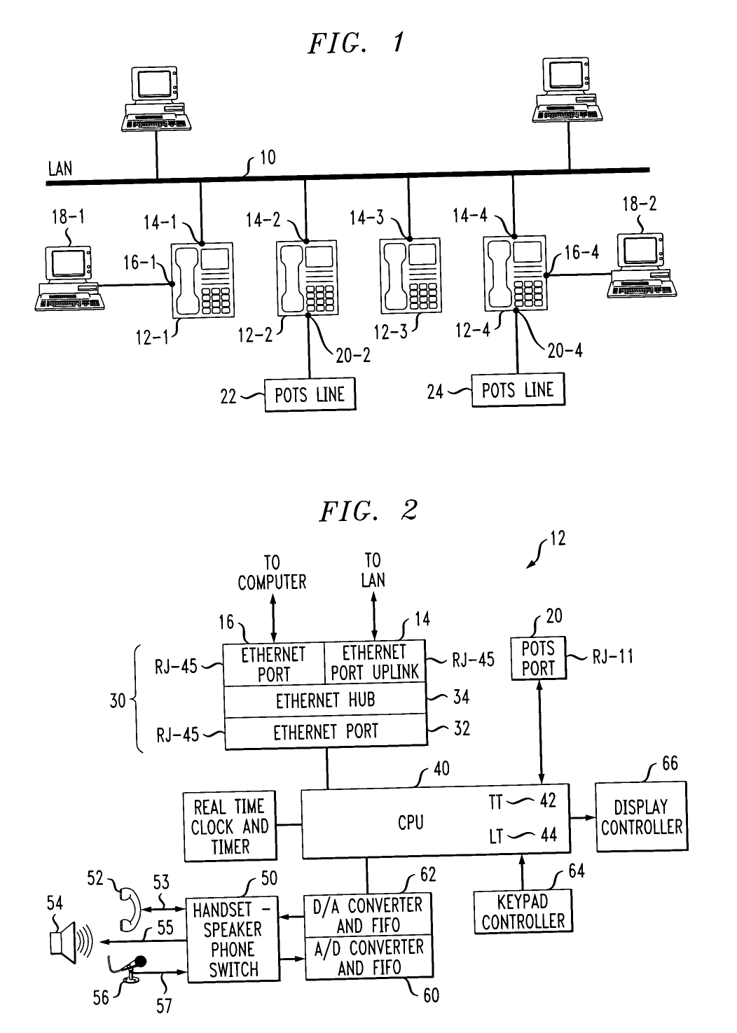

FIG. 2 illustrates, in a simplified block diagram view, the various hardware elements that comprise an intelligent communication terminal 12 formed in accordance with the present invention. Comparing the diagram to the discussion of FIG. 1, Ethernet ports 14 and 16 are shown in the diagram of FIG. 2, as well as the POTS port 20. In general, an Ethernet connection element 30 within each terminal 12 comprises “local” Ethernet port 16, LAN Ethernet port 14, and an “internal” Ethernet port 32 for communication with an internal CPU 40, as will be explained in detail hereinbelow. An Ethernet hub 34, located within element 30, is used to control the routing of messages between each of the ports within Ethernet element 30.

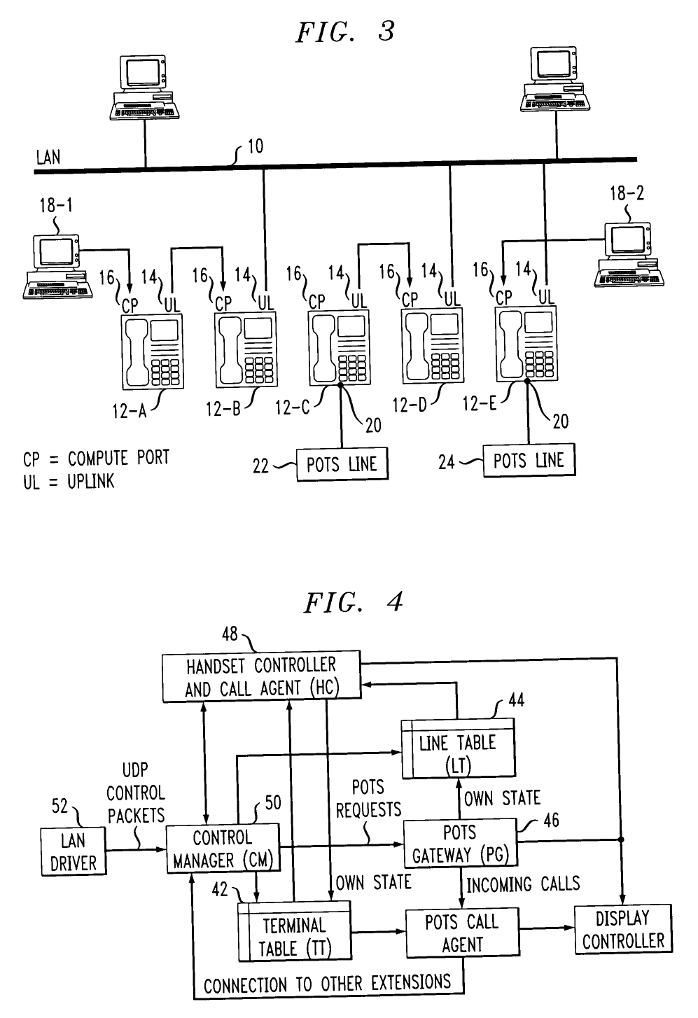

CPU 40 includes many of the elements required to provide communication between intelligent terminals 12, as well as between terminals 12 and the outside world. In particular, CPU 40 includes a “terminal table” 42 of information identifying that particular device, and the state(s) of the device, and a “line table” 44 associated with the POTS information for that terminal. Terminal table 42 contains a list of all “current” intelligent terminals, their extensions, ID and static/dynamic state information. Similarly, line table 44 contains static and dynamic state information about the POTS lines. FIG. 4, as will be discussed below, explains in detail in the inner workings of CPU 40 so as to provide communication in accordance with the present invention. Other particular memory configurations may be used in place of terminal table 42 and line table 44, as long as the same information is stored within terminal 12 and accessible for use in providing communication among the terminals. Indeed, a single table configuration may be employed, with a “terminal” partition and a “line” partition. Other arrangements are also suitable.

Referring back to FIG. 2, each intelligent communication terminal 12 further comprises an audio interface element 50, illustrated in this particular example as coupled to a telephone handset 52 (through a bi-directional communication path 53), a speaker 54 (through an outgoing communication path 55) and a microphone 56 (through an incoming communication path 57). Speaker 54 and microphone 56 are generally formed as part of a “console” of an intelligent communication device, such as terminal 12. Therefore, two separate communication paths can be established with a single intelligent terminal of the present invention, a “console” communication using the speaker and microphone, and a “handset” communication using the communication abilities of the handset itself. As discussed above, terminal 12 of the present invention relies on the transmission of digital information to provide communication. Therefore, an A/D converter 60 and a D/A converter 62 are disposed between audio interface 50 and CPU 40, so that CPU 40 receives digital input and audio elements 52, 54 and 56 function using traditional “analog” voice signals. A separate keypad controller 64 is illustrated in FIG. 2 as providing communication from terminal 12 to CPU 40, where keypad controller 64 may simply comprise a traditional telephone keypad providing DTMF signals to CPU 40. A separate display controller 66 is illustrated in FIG. 2 and is coupled to CPU 40, where display controller 66 functions as the visual indicator for intelligent communication terminal 12 (displaying, for example, “caller ID” information for an incoming outside call), and “extension ID” information for an intra-location call (also referred to as “intercom” mode of intelligent terminal 12). A “timing element” 68 is illustrated as an additional component in FIG. 2, where for arrangements in which CPU 40 does not include internal timing clocks, the necessary “real time” clock and timing events can be provided by this element.

In its simplest form, a single intelligent communication terminal 12 can function as a conventional “stand-alone” POTS phone in the context of the present invention, as long as POTS port 20 is connected to a viable POTS line. At the next level of complexity, this single device may be then be connected through its Ethernet port 14 to backbone 10. In this case, service is initiated by terminal 12 broadcasting to the LAN, looking for other terminals. After a discovery interval (where, in this case, no other terminals respond), terminal 12 will configure itself as “extension 001”, and insert this value in its internal terminal table 42 (within its CPU 40). It is to be understood that an individual user may desire to modify this self-identified extension number, and can do so at any time by merely inputting this information (using the keypad, for example), into terminal table 42.

Referring to FIG. 3, intelligent communication terminal 12-E may be defined as this “first” terminal; connected to POTS line 24 through a POTS port 20 and to backbone 10 through uplink Ethernet port 14. In this particular example, a local computer 18-2 is connected to terminal 12-E through a computer Ethernet port 16. Additional terminals 12-A through 12-D, as shown in FIG. 3, may also be plugged into the LAN via interconnection with backbone 10. The various available “voice paths” within the network are then defined and developed as a function of the interconnections between the intelligent communication terminals. For example, presume that one additional intelligent terminal, such as terminal 12-D is added to the arrangement. As shown in FIG. 3, terminal 12-D is only connected through its Ethernet port 14 to backbone 10. When intelligent terminal 12-D first broadcasts its presence, it will discover “extension 001” as associated with terminal 12-E, and will therefore define itself as “extension 002”. Terminal tables 42 for both devices will then be updated (automatically) to reflect this addition.

With the establishment of a second terminal on the LAN (albeit with a single POTS connection), there are at least four different voice paths that may be established, identified as follows: (1) terminal 12-E initiates a conventional POTS call through port 20 and into POTS lines 24; (2) terminal 12-E initiates an “intercom” call to terminal 12-D by dialing extension “002” (alternatively, terminal 12-D may initiate the intercom by dialing extension “001”); (3) terminal 12-D may gain access to POTS line 24 (by dialing a pre-defined number—such as a “9”—associated with a request for an outside line). Presuming that terminal 12-E is not using this line (as will be determined by accessing the line table in terminal 12-D), terminal 12-D will receive dialtone and thereafter proceed to place a conventional call; and (4) a conference call may be initiated (for example, by terminal 12-E), by terminal 12-E first performing an “intercom” call to extension 002, and then placing a POTS call through port 20, with terminal 12-D (via intercom) thus participating in the conference call.

If the above two terminal example is extended to an arrangement where both terminals have access to outside POTS lines (operating with separate POTS lines), the various combinations of possible voice paths will increase, with the possibility that terminal 12-E could place an outgoing call over the POTS line associated with terminal 12-D, and vice versa. Indeed, the terminal tables and line tables within each intelligent terminal device, in accordance with the present invention, are critical components in terms of maintaining an awareness of the “state” of each terminal and each line at any point in time. In accordance with the present invention, a single terminal device may be involved in two separate conference calls (a first one using the communication capabilities of its handset and a second one using the communication capabilities of its base). Moreover, an advantage of the present invention (as compared with conventional PBX-based systems) is that the number of phones on the system may be increased without limiting the operation of the remaining terminals (merely requiring an update of each terminal's line table and terminal table). By contrast, a PBX has limited computer power, and there is a limit to the number of separate terminals that be used “behind” a PBX switch.

As shown in the particular embodiment FIG. 3, individual units are either directly connected to backbone 10 (for example, terminals 12-B and 12-D are directly connected to backbone 10), or are “daisy-chained” through already-established connections. In this case, terminal 12-A is coupled to terminal 12-B, where the Ethernet “uplink”/LAN port 14 for terminal 12-A is coupled to the “local computer” Ethernet port 16 of terminal 12-B. Similarly, uplink port 14 of terminal 12-C is applied as the “computer” input at port 16 of terminal 12-D, thus giving terminal 12-C access to the LAN through terminal 12-D. Obviously, these various components can be re-arranged as need be, without requiring any “computer technician” or “telephone installation specialist” to perform the re-configuration. Each terminal will always broadcast its current state across the backbone, so the tables within each terminal will constantly be updated and always aware of the conditions of every other terminal on the network. This is clearly one of the distinct advantages of the arrangement of the present invention.

FIG. 4 depicts, in an overview fashion, the exemplary control arrangement contained within each intelligent terminal formed in accordance with the present invention. As mentioned above, this control architecture is contained within CPU 40 and includes, among other elements, terminal table 42 (associated with LAN communications) and line table 44 (associated with POTS communications).

In the case of POTS-based communication connections, the “static” state information will be contained within line table 44. The “static” information stored in line table 44 will include, for example, the outside line number, call restrictions (if any)—such as “no long distance”, restricted area codes, restricted exchanges, restricted usage hours/days. Dynamic state information (e.g., “available”, “busy”) will be queried from a POTS gateway 46, as needed. The configuration of the complete LAN will be contained within each line table 44. Additionally, POTS gateway 46 will be the “master” location for the POTS line status of its associated terminal. Also contained within line table 44 is POTS gateway 46 will hold the POTS line status information, where the “state” may be one of the following: (1) disabled (not working, either not connected to a line, or a line not working); (2) available (on-hook); (3) receiving a call (off-hook, but not yet connected to an extension; and (4) in use (off-hook and connected to extension). Once a connection is established, the following information can be queried from POTS gateway 46 each time it is needed: a call timer, caller ID (for incoming calls), and a listing of the extension(s) connected to for the particular call.

As mentioned above, the static state information for LAN-based communications (i.e., intercom voice traffic between terminals) will be maintained in the terminal table 42 within each terminal device 12. Dynamic state information associated with LAN communication will be queried from a handset controller 48 as needed. In a manner similar to the use of POTS gateway 46, the “master” location for terminal status information is contained within handset controller 48 of that particular terminal. In a particular embodiment, this terminal status information may include the following: firmware version number (ROM ID), extension number, user name, password1 (for modifying configuration), password2 (for updating software), LAN domain address (default address—FF.FF.FF.0), LAN IP address (may be function of assigned terminal extension number), MAC address, voice port default number, control port default number. Additional information that may be included within terminal table 42 is associated with additional features, such as speed dial keys, tone preferences (ring tone, on-hold tone, call waiting indicator, etc.,), phone restrictions (as defined above), volume control, call blocking

The software required to implement the calling features of the present invention is divided into two major components: (1) voice data transfer and (2) control. It is to be presumed that voice data traffic will be given higher priority and will be processed during low-level interrupt handling. Control signals will be processed using low priority tasks. In particular, LAN traffic will be directed into two separate ports, as will be discussed in detail below in association with FIG. 5: a first port for voice data and a second port for control packets.

The specific “control” information includes (at least) the following global parameters: voice message availability and its IP address; flag (used to automatically forward a new call for busy handsets to a voice messaging systems); terminal extension numbers and associated IP address; if an automated attendant is included, the attendant IP address; an initial start-up ID address (defaults to, for example, 192.168.254.255)—a temporary addressed to be used by the terminals upon start-up and used during initialization to allow discovery of other terminals on the LAN; and IP domain and mask (defaults to 192.168.254.0 and 255.255.255.0, respectively).

The specific “control” information associated with LAN communications and contained within terminal table 42 includes the following: (1) ID and set-up information, such as terminal type, terminal model, terminal version number, terminal IP address, UDP port, extension number, user name, flag(s), hunt group list; and (2) state information, such as is the line connected, handset state (queried from handset controller 48 as needed). The specific “control” information associated with POTS communications and contained within line table 44 includes the following: (1) ID information, such as POTS type (tone/pulse dialing), phone number (area code, local exchange number), line IP address, UDP port, hunt group list; and (2) restrictions, such as reserved for defined extensions, “do not use” extension list, permitted area codes, blocked area codes, etc; and (3) state information, contained in line table 44 for quick identification of available lines. However, this information needs to be verified, from time to time, from the associated POTS gateway 46. That is, when POTS calls are initiated, the call will be preferentially sent to the first POTS line marked as “available”. Each available line will be queried for its current state. If all such lines are unavailable, the remaining lines (those otherwise marked) will be queried in turn. If all of the POTS lines are unavailable, no connection will be established. The state information within line table 44 will also include: time of last status update, “no connection”, “available” or “in use”.

Control manager 50 within terminal 12, as shown in FIG. 4, is responsible for communicating with other terminals and lines, through a LAN driver 52. The status of every handset and every POTS line on the network is maintained by each control manager 50. All of the software-based processes associated with the elements of FIG. 4 are event-driven. In particular, “event” sources include the LAN itself (event input via LAN driver 52), user interface (i.e., keypad and buttons), POTS line and timer. The “high priority” communication traffic includes voice data transfers between the LAN, the terminal handset and the POTS interface. In a preferred embodiment, the LAN communication is based upon UDP stacks and packets. UDP is preferred since it is “connectionless”, eliminating the overhead associated with setting up and taking down communication paths. Incoming LAN packets are picked up by control manager 50 from LAN driver 52, and acted upon or passed to the appropriate control task. Most broadcast messages are interpreted by control manager 50. Additionally, control manger 50 will periodically broadcast its own handset and POTS line status to the LAN so as to received by the other terminals on the network. On start-up, control manager 50 will broadcast its presence, search for other terminals on the LAN, and synchronize its terminal table 42 and line table 44 with the other terminals on the network.

The domain of intelligent terminals 12 will be fixed, and default to 192.168.254.0 (for example), with a mask of FF.FF.FF.0, where it is to be understood that these values may be re-defined by the user. Preferably, the last section of the IP address for a given terminal 12 will match that terminal's assigned extension (e.g., for extension “21”, the IP address will be 192.168.254.21). The IP ports for “voice” and “control” are also configurable and selected so as to not interfere with any pre-assigned port numbers, or industry-standard port numbers. A request to access the handset or a POTS line may be initiated by the LAN. Control manager 50 will check the state of its communication component (terminal or POTS line) and respond to the request accordingly. Control manager 50 also performs functions such as creating a local ring tone for incoming calls, or creating a timed reminder tone for a line on “hold”.

Handset controller 48 responds to handset and keypad events, as well as to incoming calls. Handset controller 48 also functions as a call agent when calls to an outside line are placed from that particular intelligent terminal 12 (in most cases, using a prefix dialed digit of “9” to indicate the desire to place an outside call), or when that terminal wishes to communicate with another terminal on the LAN. Handset controller 48 validates the user event, checks terminal table 42 and line table 44. In particular, if a user dials just an extension number, handset controller 48 will check its terminal table 42 to determine the status of the dialed extension. For making outside calls, handset controller 48 contacts an available POTS gateway 46 and initiates a session with that gateway. Once the session is initiated, POTS gateway 46 will connect to the outside (POTS) line. A full duplex voice path is set up between the handset and the POTS line, where the digits dialed by the user will be sent as control packets to POTS gateway 46.

POTS gateway 46, as mentioned above, controls the requests for outgoing calls to the POTS lines, as well as calls coming in from the POTS lines. POTS gateway 46 maintains the current line state, including caller ID for an incoming call. Incoming calls on the POTS line create an “interrupt” from the modem, where the interrupt event is passed to POTS gateway 46. For embodiments of the present invention that include an automated attendant, the incoming call will be passed to the attendant. Otherwise, the incoming call will be broadcast to all intelligent terminals 12 on the LAN. Control manager 50 within each terminal 12 with a handset (terminal) status of “available” then generates a ring tone for its associated terminal 12. The specific terminal that first picks up (goes off-hook) transmits a response to the originating POTS gateway 46, where gateway 46 will take this line off-hook and then set up a full duplex voice path between itself and the first-answering terminal.

With this understanding of the control communications, as depicted in FIG. 4, it is now possible to understand the various possibilities for voice traffic flow, as shown in FIG. 5. In general, the voice traffic communications are split into two groups: voice traffic associated with the “handset”/terminal communication (block 70 in FIG. 5), and voice traffic associated with a POTS line (incoming or outgoing), as shown by block 72 in FIG. 5.

Incoming voice packets from LAN driver 52 are sorted based on the connection state of the particular intelligent terminal 12, as well as the source address (distinguishing the communication “source” as either another terminal on the LAN or an outside POTS line). In one embodiment of the present invention, encryption/decryption can be used to ensure secure communication across the LAN. If such techniques are employed, the packets are first decrypted and then routed to the appropriate source. Voice packets destined for terminal communication (block 70) are first processed by copying the voice data to a pair of buffers 74-1 and 74-2; one for each voice source. A maximum of two voice sources are permitted for each handset, as well as for each POTS line (thus providing for conference calling on either line type). During conference calls involving the terminal communications, voice data from buffers 74-1 and 74-2 will be merged on the fly within element 76, as it is being copied to audio output FIFO 62-2, and thereafter converted to analog form in D/A converter 62-1 and provided as output through speaker 54. Voice input data from the terminal set is provided through A/D converter 60-1, audio-in FIFO 60-2, and then subjected to echo cancellation within module 84 before transmitted out over the LAN. Again, if a secure communication system is being used, the voice data destined for the LAN will be subjected to encryption prior to entering the LAN.

In a similar manner, input voice data from the LAN that is destined for the POTS line is forwarded to a pair of buffers 80-1 and 80-2, and then merged on the fly within an element 82 and forwarded to an audio output FIFO 88. The digital voice is then converted to analog signal within a D/A converter 80 and coupled into POTS port 20, as shown.

At this point, it is now possible to understand the various communication scenarios that may take place within the intelligent terminal communication network of the present invention. In general, the various types of communication include handset-to-handset (intercom), handset-to-POTS line (outgoing call), and POTS line-to-handset (incoming call).

In a handset-to-handset “intercom” call, the following steps are followed in accordance with the present invention: (1) a user picks up his/her handset and associated handset controller 48 changes its status to “off-hook”. If other terminals are indeed included in the LAN and are available, a local dial tone will be generated and “played” for the off-hook handset. The user then proceeds to dial the digits associated with the other terminal, and as the digits are dialed, handset controller 48 looks up the dialed extension within terminal table 42. If the dialed extension number is found, the handset is connected to that terminal. Otherwise, an error tone is generated and “played” for the off-hook handset. Next, handset controller 48 (functioning as a call agent), queries the destination handset for “availability”. The handset controller 48 within the destination handset then responds appropriately. For example, if in an “idle” state, the destination terminal table 42 will change to “connected”, and set up a full duplex voice path with the requesting terminal. In an embodiment where secure communication is desired, the initiating handset controller 48 may generate a private and public encryption key pair, sending the public encryption key to the accepting destination terminal. Alternatively, if the destination's terminal table 42 has a “busy” state, it may reply with a call forward to voice messaging command (or merely a “busy” signal). Obviously, at call termination each terminal table will change state to reflect the end of the call.

In a handset-to-POTS line call, the following steps are followed in accordance with the present invention: (1) a user picks up his/her handset and dials the predetermined number associated with making an “outside” call (nominally, a “9”). When a “9” is first dialed (followed by the “destination number” the user is calling), handset controller 48 functions as a call agent and looks for available lines in the “hunt group” associated with this device. Those marked “available” in line table 44 are then successively queried until a line replies that it is, indeed, available. If no line responds, handset controller 38 transmits an “error” signal of some sort (for example, a “fast busy”) to the user.

Presuming that an available line responds to the query from handset controller 48, the POTS gateway 46 associated with the destination number replies with a “line available” message. A connection is set up with the first destination POTS gateway 46 that accepts the call. Additional POTS gateways accepting the call will be sent a call termination message to release them from the call. The destination POTS gateway 46 that accepts the call then sets up a full-duplex voice path to its modem and broadcasts a line status change message to all of the terminals on the LAN.

Handset controller 48 at the source, upon receiving the “line available” message, will continue to wait for additional digit keys to be pressed. As the keys are pressed, they are validated against call restriction tables for the local handset. An invalid combination of keys will cause immediate termination of the call, and generate a local error tone. Presuming the entered digits are valid, destination POTS gateway 46 validates the digits against its call restrictions, with valid digits passed to the modem to be sent out as DTMF tones or pulse dialed numbers, as used for a conventional call. Call termination with thereafter occur when the source handset goes back on-hook.

For incoming POTS calls (when no attendant is present), a source modem detects an incoming call “ring”, generates an interrupt ad passes the call to a source POTS gateway 46. Gateway 46 then broadcasts a message to all terminals, indicating the incoming call, line number and caller ID (if available). The terminals with their handset in the “idle” state, and in the same hunt group as the source POTS gateway 46 will generate a single ring tone of a predetermined duration. When a particular handset (referred to as the “destination handset”) goes off-hook to take the call, handset controller 48 for that phone sends an “incoming call accept” message to the source POTS gateway 46. Source POTS gateway 46 then ignores any further “accept” messages that may arrive from other handsets, sends an “acknowledge” message to the first handset controller 48 and a full duplex voice path is established between the incoming POTS call and the “destination” handset. For the duration of this call, the incoming POTS line will broadcast a “busy” message to the rest of the terminals on the LAN. 471 For a system that includes an attendant station on the LAN, an incoming POTS call will be directed to the attendant, where if the attendant is not in a “busy” state, a full duplex voice path is set up between the incoming POTS line and the attendant.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A telecommunications terminal for providing voice communications along separate communication paths including at least one POTS line and along a LAN-based data path interconnecting a plurality of telecommunications terminals, the telecommunications terminal comprising
a first communication port for providing communication between the plurality of telecommunications terminals across the LAN;
a POTS telecommunications port for providing communication along the at least one POTS line; and
a central processing unit coupled to both the first communication port and the POTS telecommunications port, the central processing unit including terminal information identifying LAN-based communication information associated with the telecommunications terminal and line information identifying POTS communication information associated with the telecommunications terminal, including a POTS telephone line number and the current POTS line-based operating status of said telecommunications terminal.

2. A telecommunications terminal as defined in claim 1 wherein the central processing unit includes a database comprising a first table of terminal information and a second table of line information.

3. A telecommunications terminal as defined in claim 1 wherein the terminal information includes an IP address of the telecommunications terminal and the current LAN-based operating status of said telecommunications terminal, and the line information includes a POTS telephone number line and the current POTS line-based operating status of said telecommunications terminal.

4. A telecommunications terminal as defined in claim 1 wherein the terminal further comprises
a D/A converter and associated output FIFO buffer for providing communication between the central processing unit and output voice signal paths for POTS and LAN-based communications, updating information associated with the status of communication; and
an A/D converter and associated input FIFO buffer for providing communication between POTS and LAN-based input voice signal paths and the central processing unit, updating information associated with the status of communication.

5. A telecommunications terminal as defined in claim 1 wherein the terminal further comprises
a second communication port providing communication between the telecommunications terminal and a local computer; and
a communication hub, the first and second communication ports coupled to the communication hub, with the communication hub connected in turn to the central processing unit.

6. A telecommunications terminal as defined in claim 1 wherein the first communication port comprises an Ethernet communication port.

7. A telecommunications terminal as defined in claim 1 wherein the first communication port comprises a wireless communication port.

8. A telecommunications terminal as defined in claim 5 wherein the second communication port comprises an Ethernet communication port.

9. A telecommunications terminal as defined in claim 5 wherein the second communication port comprises a wireless communication port.

10. A telecommunications terminal as defined in claim 1 wherein the telecommunications terminal is capable of operating in a secure communication system and includes
an encryption module for translating incoming voice communication to encrypted communication before coupling to the LAN-based telecommunication path; and
a decryption module for translating LAN-based communication entering the telecommunications terminal into conventional voice communication signals.

11. A LAN-based telecommunications arrangement comprising a plurality of communication terminals coupled along a backbone communication path, each communication terminal comprising:
a first communication port for providing communication between the plurality of telecommunications terminals across the LAN;
a POTS telecommunications port for providing communication along the at least one POTS line; and
a central processing unit coupled to both the first communication port and the POTS telecommunications port, the central processing unit including terminal identifying LAN-based communication information associated with each telecommunications terminal on the LAN and line information associated with each telecommunications terminal on the LAN.

12. A LAN-based telecommunications arrangement as defined in claim 11 wherein each communication terminal further comprises
a D/A converter and associated output FIFO buffer for providing communication between the central processing unit and output voice signal paths for POTS and LAN-based communications, updating information associated with the status of communication; and
an A/D converter and associated input FIFO buffer for providing communication between POTS and LAN-based input voice signal paths and the central processing unit, updating information associated with the status of communication.

13. A LAN-based telecommunications arrangement as defined in claim 1 wherein at least one communication terminal further comprises
a second communication port providing communication between the telecommunications terminal and a local computer; and
a communication hub, the first and second communication ports coupled to the communication hub, with the communication hub connected in turn to the central processing unit.

14. A LAN-based telecommunications arrangement as defined in claim 11 wherein at least one communication terminal first communication port comprises an Ethernet port.

15. A LAN-based telecommunications arrangement as defined in claim 11 wherein at least one communication terminal first communication port comprises a wireless communication port.

16. A LAN-based telecommunications arrangement as defined in claim 13 wherein at least one communication terminal second communication port comprises an Ethernet port.

17. A LAN-based telecommunications arrangement as defined in claim 13 wherein at least one communication terminal second communication port comprises a wireless communication port.

18. A LAN-based telecommunications arrangement as defined in claim 13 wherein the arrangement is used to provide secure communications and each communication terminal further comprises
an encryption module for translating incoming voice communication to encrypted communication before coupling to the LAN-based telecommunication path; and
a decryption module for translating LAN-based communication entering the telecommunications terminal into conventional voice communication signals.
